(19) United States
(12) Patent Application Publication
(10) Pub. No.: US 2026/0313581 A1
(43) Pub. Date: Oct. 8, 2026

(54) WIRELESS LOCATION UPDATE FOR CELLULAR NETWORK

(71) Applicant: QUALCOMM Incorporated, San Diego, CA (US)

(72) Inventors: Ahmed BEDEWY, Hillsborough, NJ (US); Navid ABEDINI, Basking Ridge, NJ (US); Junyi LI, Greentown, PA (US); Tao LUO, San Diego, CA (US)

(21) Appl. No.: 19/098,895

(22) Filed: Apr. 2, 2025

(51) Int. Cl. H04W 60/04; H04W 12/084; H04W 36/14; H04W 64/00

(52) U.S. Cl. CPC H04W 60/04; H04W 12/084; H04W 36/14; H04W 64/00

(57) ABSTRACT

An apparatus has one or more memories and one or more processors coupled to the one or more memories. The processor(s) is configured to receive an indication of whether to skip a registration and location update in response to entering a new area. The processor(s) is also configured to move to the new area while in idle/inactive mode. The processor(s) is further configured to skip the registration and location update in the new area, in response to receiving the indication when the indication instructs the UE to skip the registration and location update. The processor(s) is still further configured to transmit, to a network entity, the registration and location update in the new area, in response to not receiving the indication or in response to the indication instructing the UE not to skip the registration and location update.

### FIELD OF THE DISCLOSURE

The present disclosure relates generally to wireless communications, and more specifically to energy efficient location updating from a user equipment (UE).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

Aspects of the present disclosure are directed to an apparatus. The apparatus has one or more memories and one or more processors coupled to the one or more memories. The processor(s) is configured to receive an indication of whether to skip a registration and location update in response to entering a new area. The processor(s) is also configured to move to the new area while in idle/inactive mode. The processor(s) is further configured to skip the registration and location update in the new area, in response to receiving the indication when the indication instructs the UE to skip the registration and location update. The processor(s) is also configured to transmit, to a network entity, the registration and location update in the new area, in response to not receiving the indication or in response to the indication instructing the UE not to skip the registration and location update.

Other aspects of the present disclosure are directed to an apparatus. The apparatus has one or more memories and one or more processors coupled to the one or more memories. The processor(s) is configured to transmit, to a user equipment (UE), an indication of whether to skip a registration and location update in response to the UE entering a new area. The processor(s) is also configured to receive a location update in accordance with the indication.

In other aspects of the present disclosure, a method of wireless communication at a user equipment (UE) includes receiving an indication of whether to skip a registration and location update in response to entering a new area. The method also includes moving to the new area while in idle/inactive mode. The method further includes skipping the registration and location update in the new area, in response to receiving the indication when the indication instructs the UE to skip the registration and location update. The method still further includes transmitting, to a network entity, the registration and location update in the new area, in response to not receiving the indication or in response to the indication instructing the UE not to skip the registration and location update.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a diagram illustrating a user equipment (UE) performing location updates while moving across areas, in accordance with various aspects of the present disclosure.

FIG. 5 is a diagram illustrating a user equipment (UE) receiving location update indications while moving across areas, in accordance with various aspects of the present disclosure.

FIG. 6 is a flow diagram illustrating an example process performed, for example, by a user equipment (UE), in accordance with various aspects of the present disclosure.

FIG. 7 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

To enable a network to track idle or inactive user equipment (UEs), the idle or inactive UEs register with a tracking area (TA) or a radio area network (RAN) notification area (RNA). The idle or inactive UEs also reconnect to/re-register with the network and provide location updates to the network. The re-registration occurs either in accordance with a configuration or occurs periodically. A new registration may also occur when the UE selects or reselects to a new cell that does not belong to the associated/registered TA/RNA.

Each location update by an idle or inactive UE incurs a large overhead for both the UE and the network because the UE performs a random access procedure, establishes a connection with the network, receives a new location update configuration, and then releases the connection. This issue is more significant for low power mobile Internet of things (IoT) devices. High mobility scenarios, where location updates become more frequent, exacerbate the issue.

Aspects of the present disclosure are directed to saving overhead and energy for both the network and UE, based on UE registration and location updates, while the UE is in an idle or inactive state and moving around. Certain aspects enable the UE to skip performing a location update, saving energy for both the UE and the network. In some aspects, a number of location updates is reduced.

According to aspects of the present disclosure, an idle or inactive UE receives an indication of whether the UE can skip performing a registration and location update, when the UE enters a new area. A new area may include, for example, a new tracking area, a new RAN area, or a new zone (e.g., defined by a set of beams). The network may transmit or broadcast a signal notifying an idle or inactive UE of whether the UE may or may not skip registration and a location update. The indication may be referred to as a ‘welcome message.’ In some aspects, when the network sends the skipping indication, the network may also provide updated information, for example, configuration of the new area, in the same message or in a different message.

A UE can be notified implicitly or explicitly by a delegate UE whether the UE may or may not skip registration and location updates. The delegate UE may have been in an idle or inactive state and registered to perform a location update, and/or the delegate UE may have been already connected. The network can implicitly or explicitly indicate to the delegate UE to notify other UEs in the same group whether they may or may not skip their registrations and location updates. In other aspects, when a delegate UE sends the skipping indication to other UEs in the group, the network may provide the updated information for the group and/or to an individual UE. The group of collaborative UEs may include one or more of a phone, laptop, watch, or smart glasses, which may or may not belong to the same person.

According to further aspects of the present disclosure, a fallback procedure may be supported via a configured timer. In these aspects, the UE may be configured with a timer. Whenever the UE moves to a new area, the UE waits for a maximum amount of time before performing registration and a location update. If the UE does not receive a registration and location update skipping indication, either from the network and/or UEs, and the timer expires, then the UE connects to and registers with the network and provides a location update.

According to some aspects of the present disclosure, the UE reports whether the UE supports the location update skipping feature. In other aspects, the network indicates network support of the location update skipping feature.

Particular aspects of the subject matter described in this disclosure can be implemented to realize one or more of the following potential advantages. In some examples, the described techniques, such as receiving an indication for whether to skip registration and location updating, may improve energy utilization and spectrum utilization for UEs and network devices.

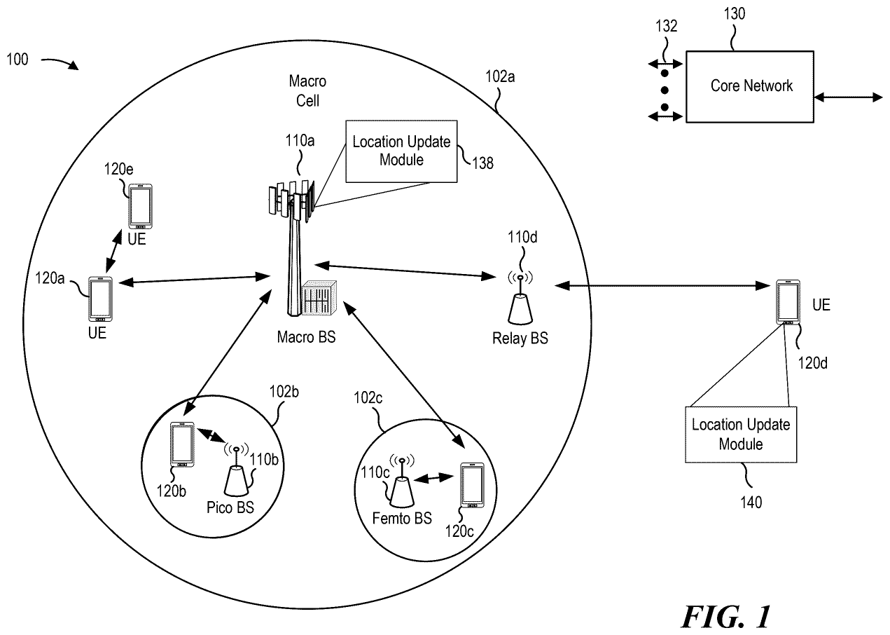

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a location update module 140. For brevity, only one UE 120d is shown as including the location update module 140. The location update module 140 may receive an indication of whether to skip a registration and location update in response to entering a new area. The location update module 140 may skip the registration and location update in a new area, in response to receiving the indication when the indication instructs the UE to skip the registration and location update. The location update module 140 may transmit, to a network entity, the registration and location update in the new area, in response to not receiving the indication or in response to the indication instructing the UE not to skip the registration and location update.

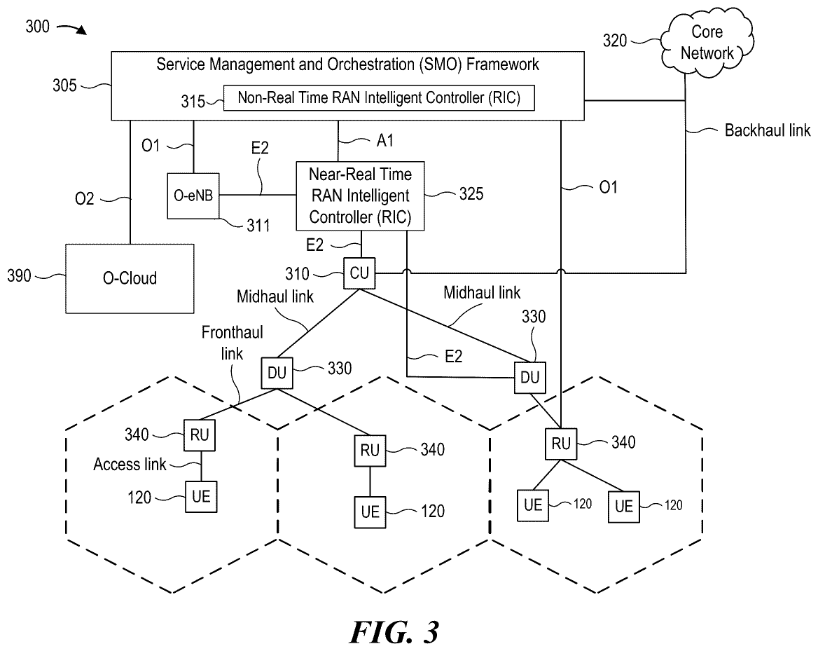

The core network 130 or the base stations 110 or any other network device (e.g., as seen in FIG. 3) may include a location update module 138. For brevity, only one base station 110a is shown as including the location update module 138. The location update module 138 may transmit, to a user equipment (UE), an indication of whether to skip a registration and location update in response to the UE entering a new area. The location update module 138 may receive a location update in accordance with the indication.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet of things (IoT) devices, and/or may be implemented as NB-IoT (narrowband Internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

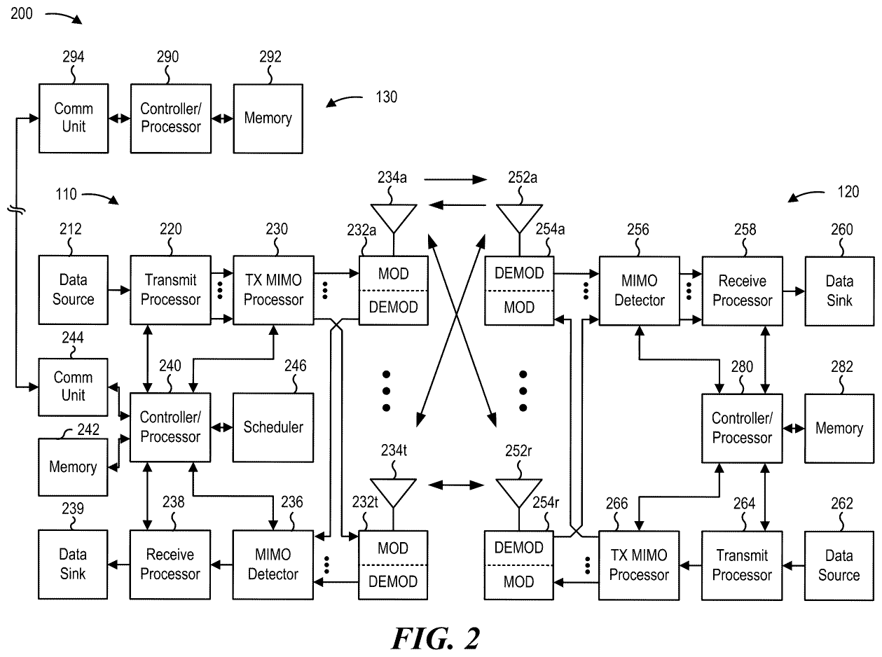

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

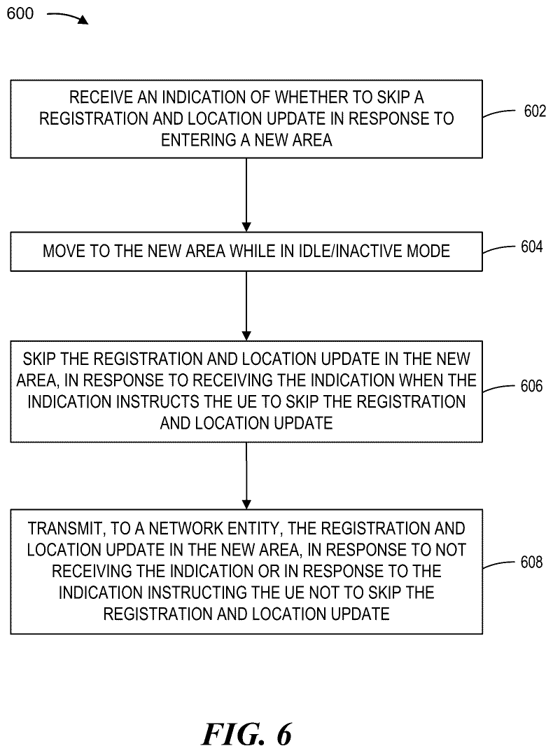

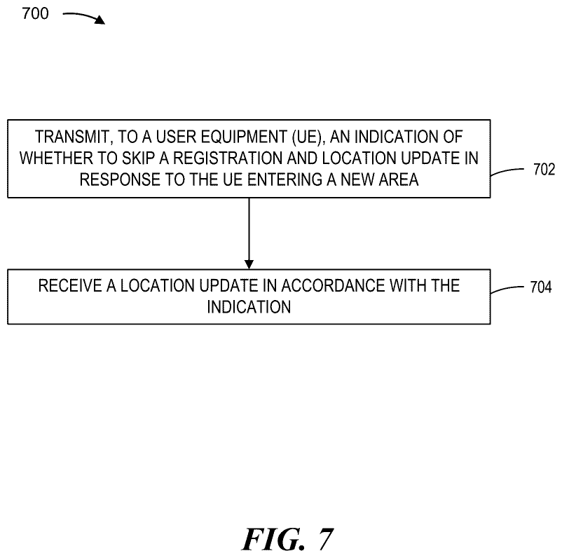

The controller/processor 240 of the base station 110, the controller/processor 280 of the UE 120, and/or any other component(s) of FIG. 2 may perform one or more techniques associated with improved location updating, as described in more detail elsewhere. For example, the controller/processor 240 of the base station 110, the controller/processor 280 of the UE 120, and/or any other component(s) of FIG. 2 may perform or direct operations of, for example, the processes of FIGS. 6 and 7 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for moving, means for skipping, means for transmitting, means for waiting, means for performing, and means for reporting. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

To enable a network to track idle or inactive user equipment (UEs), the idle or inactive UEs register with a tracking area (TA) or a radio area network (RAN) notification area (RNA). The idle or inactive UEs also reconnect to/re-register with the network and provide location updates to the network. The re-registration occurs either in accordance with a configuration or occurs periodically. A new registration may also occur when the UE selects or reselects to a new cell that does not belong to the associated/registered TA/RNA.

Each location update by an idle or inactive UE incurs a large overhead for both the UE and the network because the UE performs a random access procedure, establishes a connection with the network, receives a new location update configuration, and then releases the connection again. This issue is more significant for low power mobile Internet of things (IoT) devices. High mobility scenarios, where location updates become more frequent, exacerbate the issue.

Aspects of the present disclosure are directed to saving overhead and energy for both the network and UE, based on registration and UE location updates, while the UE is in an idle or inactive state and moving around. Certain aspects enable the UE to skip performing a location update, saving energy for both the UE and the network. In some aspects, a number of location updates is reduced.

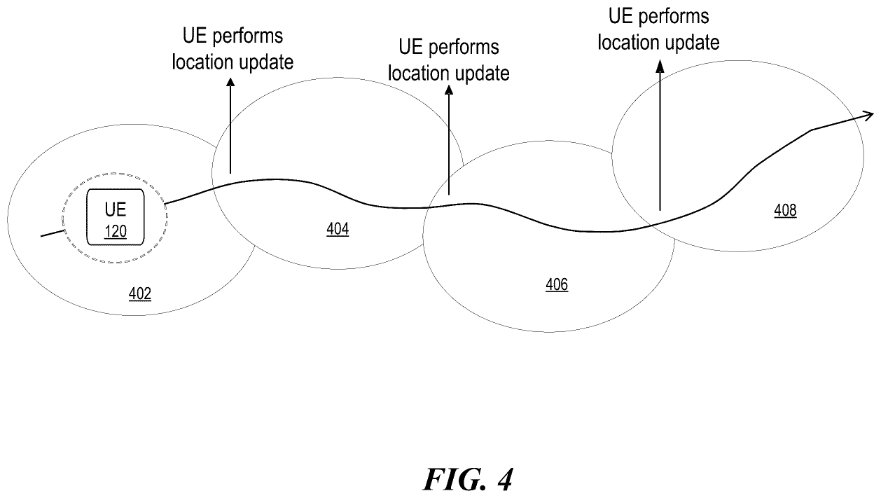

FIG. 4 is a diagram illustrating a user equipment (UE) 120 performing location updates while moving across areas, in accordance with various aspects of the present disclosure. In the example of FIG. 4, the UE 120 begins in a first area 402 and moves to second, third, and fourth areas, 404, 406, 408. When the UE 120 enters each of these areas 404, 406, 408, the UE 120 performs a location update.

The network can track the UE location by predicting a trajectory or mobility of the UE, or by UE co-location or collaboration. The network may predict the trajectory or mobility of the UE, for example, from a history of location updates or connections of the UE. Alternatively, or in addition, the UE may predict its own trajectory or mobility and share this information with the network. For example, for a UE that travels from point A to point B, the network or UE can predict which cells or areas the UE will visit along the UE trajectory.

UE co-location may help the network determine a UE location. It is noted that UE co-location does not necessarily include collaboration with other UEs. For co-located UEs, the group may include one or more of a phone, laptop, watch, or smart glasses, all belonging to the same person. When UEs are co-located, the network may determine a UE location by inferring a UE is co-located with other UE(s). The other UE(s) may or may not be idle or inactive. The network may infer a UE is co-located with another UE(s) from the location update history of these UEs, for example, if the location updates match for a certain period of time. From a trajectory or mobility prediction, the network can predict that those UE trajectories will match for a certain period of time. The network can rely on the location update or connectivity of one or more of those UEs to infer the location of the other UE.

For UE collaboration, UEs may create a group and one or more UEs, for example, a delegate UE, may inform the network about the group. For collaborating UEs, the group may include one or more of a phone, laptop, watch, or smart glasses, all belonging to the same person. Group formation may be based on a geographical area or a time duration. With UE collaboration, a delegate UE sends a location update to the network entity for itself or on behalf of the group. The delegate UE may be connected to the network, and hence, the network can infer that the current location of the delegate UE applies to other UE group members. When in connected mode, the network is aware of the location of the delegate UE.

According to aspects of the present disclosure, an idle or inactive UE receives an indication of whether the UE can skip performing a registration and location update, when the UE enters a new area. A new area may include, for example, a new tracking area, a new RAN area, or a new zone (e.g., defined by a set of beams). The network may transmit or broadcast a signal notifying an idle or inactive UE of whether the UE may or may not skip re-registration and a location update. The indication may be referred to as a ‘welcome message.’

The signal carrying the indication may be transmitted in any combination of a paging early indication (PEI), wake-up signal (WUS), low power WUS, paging physical downlink control channel (PDCCH), paging physical downlink shared channel (PDSCH), or other broadcast or multicast channel. For example, a new paging record can be defined that includes a UE identifier (ID) along with new causes or attributes, indicating, for example, whether the UE can skip registration and a location update. The indication may be sent via one or multiple cells in the new area and on one or multiple beams of these cells. In case of UE grouping, this signal can be sent to the group. For example, the signal may address a group ID.

This signal does not necessarily indicate location update skipping. The signal may also ask the UE to register with the network. For example, the network may want to refresh security or provide a new or updated mobility configuration. The indication can be explicit, for example, via a new cause value. Alternatively, the indication can be implicit. For example, the absence of a welcome message may indicate the UE should reconnect when the UE enters a new area.

Radio resource control (RRC) signaling may be employed for configuring this mode of operation for the UE. That is, when the UE is connected and/or being sent to idle or inactive state, the UE may receive RRC signaling indicating, for example, which cells, areas, and/or a duration of time that the UE may or may not expect a welcome message.

According to further aspects of the present disclosure, in response to receiving the skipping indication from the network, the idle or inactive UE may or may not send an acknowledgement (ACK) to the network. The response message may include other information, such as an updated trajectory estimation, a request to update specific information, such as security information or other information about the new area, etc. This uplink signal may be sent by the UE while the UE is still in inactive or idle state. For example, the UE may send the signal by leveraging a small data transmission (SDT) framework, as part of a reduced random access channel (RACH) process, such as in a msgA payload or MSG1 and/or MSG3 payload.

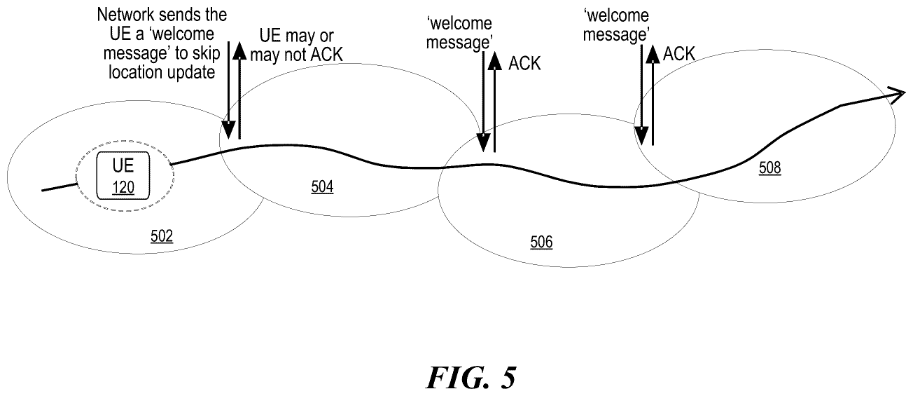

FIG. 5 is a diagram illustrating a user equipment (UE) 120 receiving location update indications while moving across areas, in accordance with aspects of the present disclosure. In the example of FIG. 5, the UE 120 begins in a first area 502 and moves to second, third, and fourth areas, 504, 506, 508. When the UE 120 enters the second area 504, the UE 120 receives an indication (e.g., ‘welcome message’) from the network. The welcome message instructs the UE 120 to skip registration and a location update for the second area 504. The UE 120 may or may not acknowledge the welcome message. When the UE 120 enters the third area 506 and fourth area 508, the UE 120 receives an indication (e.g., welcome message) from the network. The welcome message instructs the UE 120 to skip registration and a location updates for the third area 506 and fourth area 508. The UE 120 acknowledges the welcome messages in the third area 506 and fourth area 508.

UE collaboration will now be described in more detail. A UE can be notified implicitly or explicitly by a delegate UE whether the UE may or may not skip registration and location updates. The delegate UE may have been in an idle or inactive state and registered to perform a location update, and/or the delegate UE may have been already connected. The network can implicitly or explicitly indicate to the delegate UE to notify other UEs in the same group whether they may or may not skip their registrations. Cooperative registration and location updating, which will be described below, should occur in order to enable UE collaboration.

According to further aspects of the present disclosure, a fallback procedure may be supported via a configured timer. In these aspects, the UE may be configured with a timer. Whenever the UE moves to a new area, the UE waits for a maximum amount of time before performing registration and a location update. If the UE does not receive a registration and location update skipping indication either from the network and/or delegate UEs and the timer expires, then the UE connects to and registers with the network.

The timer may be configured in terms of a number N of discontinuous reception (DRX) cycles and/or an absolute time (e.g., T seconds). The timer value may be specified in a standard or configured by the network. The timer can be cell-specific, area-specific, and/or UE-specific or specific to a group of UEs. For example, within a group of collaborative UEs, the network can set a timer value to 0 for one or more UEs that will operate as delegates. In some implementations, the timer is dependent on the UE's mobility state.

In some aspects, the UE or group can suggest a value or range for the timer. The configuration of the timer can be carried in a system information block (SIB), RRC signaling, network access stratum (NAS) signaling, dedicated control signaling, or any combination of these signals. The configuration may also be delivered by a delegate UE in a collaborative group. In some implementations, the UE may estimate a timer value from previous reception times of these signals. A maximum limit may be set in this case, such that if the limit is exceeded, the UE performs registration and a location update.

Capability/feature reporting is now described. According to some aspects of the present disclosure, the UE reports whether the UE supports the registration and location update skipping feature. In other aspects, the network indicates that the network supports the registration and location update skipping feature. For example, the feature can be reported as being supported by a cell, for example, in a SIB of the cell, or supported by a group of cells in a list of cell IDs. The network may also report support by cells in indicated area(s), cells in a frequency, or cells of a given type, such as terrestrial network versus non-terrestrial network, stationary versus mobile, or macro versus small cells. Additionally, or alternatively, the network may report support by a cell of a given mode of operation. Modes of operation may include, for example, normal or network energy saving (NES), loaded or not-loaded, or any combination of these cell types. A loaded cell may refer to a cell with unified access control (UAC)-related information present in a SIB.

The network capability indication may be transmitted via a SIB, RRC signaling, NAS signaling, or any combination of such signaling. The indication may be provided by the cell itself, or by one cell for other cells in the same area or neighborhood. This information, such as a list of associated cells/frequencies, may be provided by the network to the UE when the UE was last connected. In some implementations, the information is provided on-demand. If the selected cell, upon entering a new area, does not support the feature, the UE falls back to legacy procedures and performs the location update by connecting to the network.

The monitoring for or acquisition of the indication of whether a cell or group of cells supports the registration and location update skipping feature may be performed collaboratively between collaborating UEs. For example, one UE may acquire this information and share the information with other UEs. Sharing may be conditional. For example, only if a cell or area does not support this feature, the information is shared. Otherwise, by default, other UE(s) may assume this feature is adopted by the network.

A framework for a UE to obtain new or updated mobility related information for a new area is now described. As a UE enters a new area, the UE is configured/registered with the new area for the next location update and registration. Other information may also be provided, such as refreshed security keys, etc. If the UE skips registering, the UE should still receive updated mobility-related information. In some aspects, when the network sends or broadcasts the skipping indication, the network may also provide updated information, for example, configuration of the new area, in the same message or in a different message. The updated information may include a security key, a cell ID, a frequency range, etc.

In other aspects, when a collaborative UE sends the skipping indication to other UEs in the group, the network may provide the updated information for the group and/or an individual UE. Depending on the collaborative scheme, the delegate UE may or may not share this information with other UEs. For example, if the delegate UE will be in charge of future location updates and there is no updated UE-specific information, the delegate UE may not immediately share the information with other UEs.

In further aspects, the UE may have previously been provided with a list or series of mobility-related configurations, such as a configuration of multiple areas, when the UE was previously connected. The UE may use this stored information to update the UE's configuration as the UE enters a new area, for example, upon receiving the skipping indication. The skipping indication from the network and/or collaborative UE may provide an index to this preconfigured list to be used by the UE going forward. Some of this information may be security sensitive and hence encrypted. In this case, if the delegate UE receives this information, the delegate UE temporarily acts as a relay to ship the container to the other UE(s) in the group.

A framework to enable collaborative location updates may operate with a group of collaborative UEs that may include one or more of a phone, laptop, watch, or smart glasses, all belonging to the same person. In this case, pairing may occur offline, and a policy may be configured beforehand. For example, if the phone detects the presence of the smart glasses nearby, then the phone will take care of all cellular operations (including location updates) as the master of the smart glasses. In some cases, the smart glasses may disconnect from the cellular connection. In another example, the devices belong to different users.

In order to support a framework to enable collaborative location updates, delegate UE location update schemes may include an enhanced location update, a legacy location update, or a combination of the enhanced and legacy location update. For the enhanced location update, the delegate UE sends a location update to the network entity. The location update comprises an indication that the location update applies to a group of UEs. For a legacy location update, a group is formed and registered at the network. The delegate UE sends a location update in accordance with legacy procedures. The network entity infers that location update also applies to other UEs in the group.

Examples of downstream information from a network entity to UEs to support the collaborative location update scheme are now described. In a first example, a delegate UE receives authorization from the network entity to perform location updates on behalf of a group of UEs. Authorization may include a condition to perform the “group” location update. The condition may be any combination of a location within a geographical area, a certain time period, or the location update being on behalf of a group of UEs including at least N members, or members having inter-UE connectivity, such as sidelink (SL) UEs or quasi-co-located members. The condition may also relate to members that can detect each other with a signal quality above a threshold level, or when a particular member or UE type is in the group. For example, a group may be created whenever two UEs (e.g., a watch and telephone) are together, and the delegate (e.g., telephone) performs updates for the watch when the watch is present in the group.

UEs in the group may receive an indication to activate or deactivate collaborative location updates. The delegate UE may receive an indication of whether to follow legacy location update procedures, enhanced location update procedures, or a combination as previously described. Authorization may be carried in a SIB, RRC signaling, NAS signaling, or any combination of the signaling. Such downstream information processing may be performed along with the previously described fallback procedure.

UE to network assistance aspects will now be described. Examples of upstream information from UEs to a network entity to support the collaborative location updating may include group information indicating that the delegate UE and/or all UEs in the group will be collaborative. The group information may be applicable for a particular geographical area or for a time duration.

The delegate UE may request to perform location updates on behalf of a group. Delegate UE change information may be transmitted, indicating if a delegate for the group has changed. The information from the UE to the network may also indicate whether the legacy location update, enhanced location update, or a combination as previously described is being employed. The UE may also transmit to the network capability information, such as an indication of whether a UE supports location update skipping. The information may indicate whether all or some UEs within the group support the feature.

Local coordination among UEs specifies signaling amongst the UEs within a group. Examples of coordination among UEs to support collaborative location updating include the implicit or explicit notifications described above, such as sending a welcome message to other UEs on behalf of the network. UEs in the group may also share some information amongst the group, such as trajectory or mobility information. The delegate UE may then inform the network of such information.

The UEs may exchange information about a scheme for collaboration among the UEs. The scheme could be switching delegates or capability sharing among UEs. Delegate UEs may switch based on a certain pattern (e.g., round robin), channel condition, or transmit receive alignment. For example, simultaneous transmission or reception by multiple UEs may occur to improve signal strength. That is, if two UEs transmit the same signal to a network device, the network device may combine the signals to improve the signal. In other aspects, a single UE always handles all communications on behalf of the other UEs, and such a scheme is shared among the group members.

Communication between UEs may be direct or indirect, for example, via a server application, such as a wireless local area network (WLAN).

According to aspects of the present disclosure, the skipping indication from the network, directly and/or possibly via a cooperative UE, can indicate a periodicity change for a periodic registration/location update. The periodicity change may be an increase in periodicity or a decrease in periodicity. A decreased periodicity may result from the network being able to predict the UE location.

To enable the location update skipping feature, upper layer signaling is specified. For example, the RAN and core network (CN) may exchange information about a UE capability and base station (e.g., gNB) cell's support of such a feature. A centralized unit (CU) may request a distributed unit (DU) to send a skipping or welcome paging indication for a UE on a given set of resources. The DU may notify the CU of whether the DU has received any acknowledgment from the UE. The RAN may notify the core network of whether a location update is performed by a UE using the location update skipping feature, for example for paging purposes.

As indicated above, FIGS. 3-5 are provided as examples. Other examples may differ from what is described with respect to FIGS. 3-5.

FIG. 6 is a flow diagram illustrating an example process 600 performed, for example, by a user equipment (UE), in accordance with various aspects of the present disclosure. The example process 600 is an example of energy efficient location updating from a user equipment (UE). The operations of the process 600 may be implemented by a UE 120.

At block 602, the user equipment (UE) receives an indication of whether to skip a registration and location update in response to entering a new area. For example, the UE (e.g., using the antenna 252, the DEMOD/MOD 254, MIMO detector 256, receive processor 258, controller/processor 280, memory 282, and/or the like) may receive the indication. The indication may be received via a plurality of cells from a network entity. In other aspects, the indication is received from another UE.

At block 604, the user equipment (UE) moves to the new area while in idle/inactive mode. For example, the UE (e.g., using the controller/processor 280, memory 282, and/or the like) may move to the new area.

At block 606, the user equipment (UE) skips the registration and location update in the new area, in response to receiving the indication when the indication instructs the UE to skip the registration and location update. For example, the UE (e.g., using the controller/processor 280, memory 282, and/or the like) may skip the registration and location update. In some aspects, the UE wait until a timer expires, the timer starting in response to moving to the new area. The UE performs the registration and location update in response to the timer expiring and either the indication to skip arrives after the timer expires or the UE does not receive the indication to skip.

At block 608, the user equipment (UE) transmits, to a network entity, the registration and location update in the new area, in response to not receiving the indication or in response to the indication instructing the UE not to skip the registration and location update. For example, the UE (e.g., using the controller/processor 280, memory 282, and/or the like) may transmit the registration and location update.

FIG. 7 is a flow diagram illustrating an example process 700 performed, for example, by a network device, in accordance with various aspects of the present disclosure. The example process 700 is an example of energy efficient location updating. The operations of the process 700 may be implemented by a base station 110.

At block 702, the base station transmits, to a user equipment (UE), an indication of whether to skip a registration and location update in response to the UE entering a new area. For example, the UE (e.g., using the antenna 234, the MOD/DEMOD 232, TX MIMO processor 230, transmit processor 220, controller/processor 240, memory 242, and/or the like) may transmit the indication.

At block 704, the base station receives a location update in accordance with the indication. For example, the UE (e.g., using the antenna 234, the MOD/DEMOD 232, MIMO detector 236, receive processor 238, controller/processor 240, memory 242, and/or the like) may receive the location update. The registration and location update in the new area may be received in response to the UE not receiving the indication or in response to the indication instructing the UE not to skip the registration and location update.

### Example Aspects

Aspect 1: An apparatus for wireless communication at a user equipment (UE), comprising: at least one memory; and at least one processor coupled to the at least one memory, the at least one processor configured: to receive an indication of whether to skip a registration and location update in response to entering a new area; to move to the new area while in idle/inactive mode; to skip the registration and location update in the new area, in response to receiving the indication when the indication instructs the UE to skip the registration and location update; and to transmit, to a network entity, the registration and location update in the new area, in response to not receiving the indication or in response to the indication instructing the UE not to skip the registration and location update.

Aspect 2: The apparatus of Aspect 1, in which the indication is received via a plurality of cells.

Aspect 3: The apparatus of Aspect 1 or 2, in which the indication is received from the network entity.

Aspect 4: The apparatus of Aspect 1, in which the indication is received from another UE.

Aspect 5: The apparatus of any of the preceding Aspects, in which the at least one processor is further configured to receive an instruction to notify another UE of the indication, as a delegate, the other UE registered as a group member for which the UE is the delegate.

Aspect 6: The apparatus of any of the preceding Aspects, in which the at least one processor is further configured: to wait until a timer expires, the timer starting in response to moving to the new area; and to perform the registration and location update in response to the timer expiring and either the indication to skip arrives after the timer expires or the UE does not receive the indication to skip.

Aspect 7: The apparatus of any of the preceding Aspects, in which the timer is based on a quantity of discontinuous reception (DRX) cycles or an amount of time measured in seconds.

Aspect 8: The apparatus of any of the preceding Aspects, in which the timer is at least one of cell-specific, area-specific, UE-specific, or specific to a group of UEs.

Aspect 9: The apparatus of any of the preceding Aspects, in which the timer is based on a mobility state of the UE.

Aspect 10: The apparatus of any of the preceding Aspects, in which the at least one processor is further configured to report a UE capability indicating support of skipping the registration and location update.

Aspect 11: The apparatus of any of the preceding Aspects, in which the at least one processor is further configured to receive updated mobility configuration information.

Aspect 12: The apparatus of any of the preceding Aspects, in which the at least one processor is further configured to perform a delegated registration and location update on behalf of an associated UE.

Aspect 13: The apparatus of any of the preceding Aspects, in which the at least one processor is further configured to receive authorization, from the network entity, to perform the delegated registration and location update on behalf of the associated UE.

Aspect 14: The apparatus of any of the preceding Aspects, in which the at least one processor is further configured to transmit a request, to the network entity, to perform the delegated registration and location update on behalf of the associated UE.

Aspect 15: The apparatus of any of the preceding Aspects, in which the at least one processor is further configured to receive mobility information from the associated UE.

Aspect 16: The apparatus of any of the preceding Aspects, in which the indication to skip further indicates a periodicity change for periodic registration and location updates.

Aspect 17: The apparatus of any of the preceding Aspects, in which the at least one processor is further configured to transmit a response to the indication including a trajectory estimate and/or a request to update specific information.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communication at a user equipment (UE), comprising:
at least one memory; and
at least one processor coupled to the at least one memory, the at least one processor configured:
to receive an indication of whether to skip a registration and location update in response to entering a new area;
to move to the new area while in idle/inactive mode;
to skip the registration and location update in the new area, in response to receiving the indication when the indication instructs the UE to skip the registration and location update; and
to transmit, to a network entity, the registration and location update in the new area, in response to not receiving the indication or in response to the indication instructing the UE not to skip the registration and location update.

2. The apparatus of claim 1, in which the indication is received via a plurality of cells.

3. The apparatus of claim 1, in which the indication is received from the network entity.

4. The apparatus of claim 1, in which the indication is received from another UE.

5. The apparatus of claim 1, in which the at least one processor is further configured to receive an instruction to notify another UE of the indication, as a delegate, the other UE registered as a group member for which the UE is the delegate.

6. The apparatus of claim 1, in which the at least one processor is further configured:
to wait until a timer expires, the timer starting in response to moving to the new area; and
to perform the registration and location update in response to the timer expiring and either the indication to skip arrives after the timer expires or the UE does not receive the indication to skip.

7. The apparatus of claim 6, in which the timer is based on a quantity of discontinuous reception (DRX) cycles or an amount of time measured in seconds.

8. The apparatus of claim 6, in which the timer is at least one of cell-specific, area-specific, UE-specific, or specific to a group of UEs.

9. The apparatus of claim 6, in which the timer is based on a mobility state of the UE.

10. The apparatus of claim 1, in which the at least one processor is further configured to report a UE capability indicating support of skipping the registration and location update.

11. The apparatus of claim 1, in which the at least one processor is further configured to receive updated mobility configuration information.

12. The apparatus of claim 1, in which the at least one processor is further configured to perform a delegated registration and location update on behalf of an associated UE.

13. The apparatus of claim 12, in which the at least one processor is further configured to receive authorization, from the network entity, to perform the delegated registration and location update on behalf of the associated UE.

14. The apparatus of claim 12, in which the at least one processor is further configured to transmit a request, to the network entity, to perform the delegated registration and location update on behalf of the associated UE.

15. The apparatus of claim 12, in which the at least one processor is further configured to receive mobility information from the associated UE.

16. The apparatus of claim 1, in which the indication to skip further indicates a periodicity change for periodic registration and location updates.

17. The apparatus of claim 1, in which the at least one processor is further configured to transmit a response to the indication including a trajectory estimate and/or a request to update specific information.

18. An apparatus for wireless communication at a network device, comprising:
at least one memory; and
at least one processor coupled to the at least one memory, the at least one processor configured:
to transmit, to a user equipment (UE), an indication of whether to skip a registration and location update in response to the UE entering a new area; and
to receive a location update in accordance with the indication.

19. The apparatus of claim 18, in which the at least one processor is further configured to transmit, to a core network, confirmation that the location update was received in accordance with the indication.

20. A method of wireless communication at a user equipment (UE), comprising:
receiving an indication of whether to skip a registration and location update in response to entering a new area;
moving to the new area while in idle/inactive mode;
skipping the registration and location update in the new area, in response to receiving the indication when the indication instructs the UE to skip the registration and location update; and
transmitting, to a network entity, the registration and location update in the new area, in response to not receiving the indication or in response to the indication instructing the UE not to skip the registration and location update.
